(19) United States
(12) Patent Application Publication
(10) Pub. No.: US 2008/0111810 A1
(43) Pub. Date: May 15, 2008

(54) Organic light emitting diode display device and driving method thereof

(76) Inventor: Sung Cheon Park, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/888,591

(22) Filed: Jul. 31, 2007

(30) Foreign Application Priority Data
Nov. 9, 2006 (KR) 10-2006-0110577

(51) Int. Cl. G09G 5/00

(52) U.S. Cl. 345/212; 315/360; 345/76

(57) ABSTRACT

An organic light emitting diode display device capable of suppressing banding noise caused by fluctuation in power consumption in a portable display device, and a driving method thereof are disclosed. The display includes pixels configured to display an image based on first and second power voltages, a first regulator for receiving a power source from a battery to generate a first power voltage and a second power voltage, and a second regulator connected to an output terminal of the first regulator to receive and control the first power voltage.

### CROSS-REFERENCE TO RELATED APPLICATIONS

This application claims the benefit of Korean Patent Application No. 2006-0110577, filed on Nov. 9, 2006, in the Korean Intellectual Property Office, the disclose of which is incorporated herein by reference.

### BACKGROUND OF THE INVENTION

1. Field of the Invention

The field relates to an organic light emitting diode display device and a driving method thereof, and more specifically to a data driver configured to maintain high image quality preventing a voltage from being shifted in a portable organic light emitting diode display device, and a driving method for the device.

2. Description of the Related Technology

In recent years, there have been various light emitting diode display devices which are light weight and small-sized when compared to cathode ray tubes. The flat panel displays include a display region in which a plurality of pixels are arranged in a matrix form on a substrate, and an image is displayed by driving scan lines and data lines connected to each of the pixels to selectively apply a data signal to the pixels.

The flat panel displays are classified into passive matrix type displays and active matrix type displays, depending on driving systems of the pixels. The active matrix type display which selectively turns on the light in every unit pixel has been widely used because of good resolution, contrast, and response time.

Flat panel displays have been used as displays or monitors of information appliances, such as personal computers, mobile phones, PDA, etc., and LCD using a liquid crystal panel, an organic light emitting diode display device using an organic light emitting diode, PDP using a plasma panel and the like have been widely known in the art, and, in particular, an organic electro-luminescence display having excellent luminous efficiency, luminance, a viewing angle and a rapid response time has been widely used.

### SUMMARY OF CERTAIN INVENTIVE ASPECTS

Embodiments provide an organic light emitting diode display device configured to maintain high image quality by suppressing banding noise caused by increases in power consumption in a portable display device, and driving methods for the device.

One aspect is an organic light emitting diode display device including a pixel unit including pixels configured to receive a data signal, a scan signal, a first power voltage, and a second power voltage, and to display an image based on the received signals and voltages. The device also includes a data driver configured to transmit the data signal to the pixel unit, a scan driver configured to transmit the scan signal to the pixel unit, a battery configured to transmit a predetermined power voltage, and a first regulator configured to receive the predetermined power voltage, to generate a first power voltage signal and the second power voltage, and to transmit the first power voltage signal and the second power voltage. The device also includes a second regulator configured to receive and to regulate the first power voltage signal to generate the first power voltage.

Another aspect is an organic light emitting diode display device including a pixel unit including pixels configured to receive a data signal, a scan signal, a first power voltage, and a second power voltage, and to display an image. The device also includes a data driver configured to transmit the data signal to the pixel unit, a scan driver configured to transmit the scan signal to the pixel unit, a battery configured to transmit a predetermined power voltage, and a first regulator configured to receive a power voltage signal, to generate the first power voltage and the second power voltage based on the received power voltage signal, and to transmit the first power voltage and the second power voltage. The device also includes a second regulator configured to receive the predetermined power voltage, to regulate the predetermined power voltage to generate the power voltage signal, and to transmit the power voltage signal to the first regulator.

Another aspect is a method of driving an organic light emitting diode display device capable of displaying an image using a data signal, a scan signal, a first power voltage, and a second power voltage. The method includes regulating a voltage received from a battery to generate the first power voltage and the second power voltage, and reducing voltage sag, where the voltage received from the battery has a first voltage sag, and the first power voltage has a second voltage sag, and the amplitude of the first voltage sag is larger than the amplitude of the second voltage sag.

Another aspect is a method of driving an organic light emitting diode display device capable of displaying an image using a data signal, a scan signal, a first power voltage, and a second power voltage. The method includes reducing ripple of a power voltage, received from a battery to generate a reduced ripple battery voltage, regulating the reduced ripple battery voltage, and generating a first power voltage and a second power voltage based on the regulated reduced ripple battery voltage.

### BRIEF DESCRIPTION OF THE DRAWINGS

These and/or other aspects will become apparent and more readily appreciated from the following description, taken in conjunction with the accompanying drawings of which:

FIG. 1 is a circuit view showing a power supply of a conventional organic light emitting diode display device.

FIG. 2 is a diagram showing one case that a pixel unit of the conventional organic light emitting diode display device emits white light.

FIG. 3 is a cross-sectional view showing an organic light emitting diode display device according to one embodiment.

FIG. 4 is a circuit view showing a pixel of the organic light emitting diode display device according to another embodiment.

FIG. 5 is a block diagram showing one embodiment of a power supply unit as shown in FIG. 3.

FIG. 6 is a block diagram showing another embodiment of a power supply unit show in FIG. 3.

### DETAILED DESCRIPTION OF CERTAIN INVENTIVE EMBODIMENTS

Embodiments will be described with reference to the accompanying drawings. Here, when one element is connected to another element, the one element may be not only directly connected to the other element but also indirectly connected to the other element by a third element.

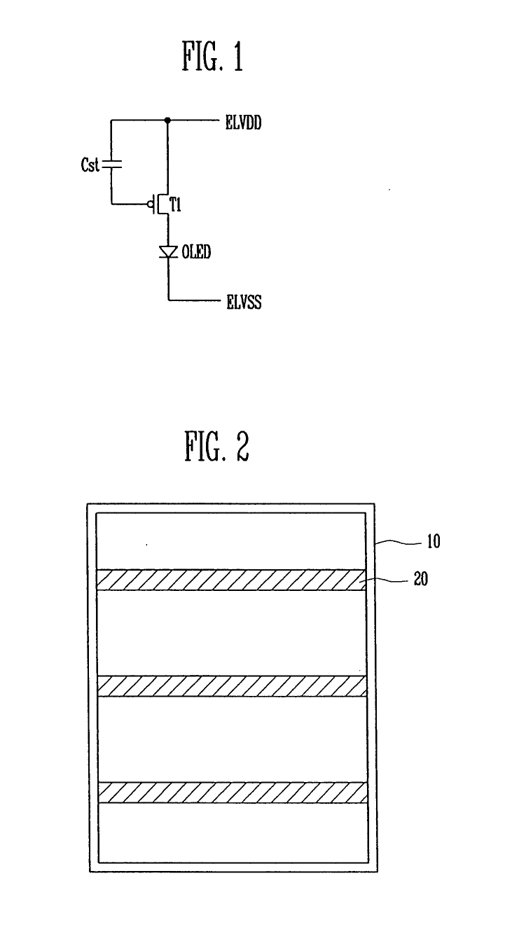

FIG. 1 is a circuit view showing a power supply of a conventional organic light emitting diode display device. In the organic light emitting diode display device, an organic light emitting diode (OLED) receives a first power voltage (ELVDD) and a second power voltage (ELVSS) to emit the light, and a transistor (T1) is operated by a data signal to control the electric current flowing to the organic light emitting diode (OLED). The electric current flowing to the organic light emitting diode (OLED) flows for a predetermined period corresponding to the data signal because the data signal is stored in the capacitor (Cst) to transmit the data signal to the transistor (T1).

Portable apparatuses, namely mobile phones, PDA, etc., which have the organic light emitting diode display device that emits the light as described above, are operated by receiving a power voltage from a battery, a first power voltage (ELVDD), and a second power voltage (ELVSS).

In particular, if one talks over the mobile phone, a ripple is caused in the first power voltage (ELVDD) and the second power voltage (ELVSS) due to fluctuations in power consumption. As a result, electric current flowing to the organic light emitting diode (OLED) does not flow constantly. Accordingly, luminance of the emitted light is not constant in the organic light emitting diode (OLED) because the organic light emitting diode (OLED) emits the light corresponding to the electric current flowing from the first power source (ELVDD) to the second power source (ELVSS).

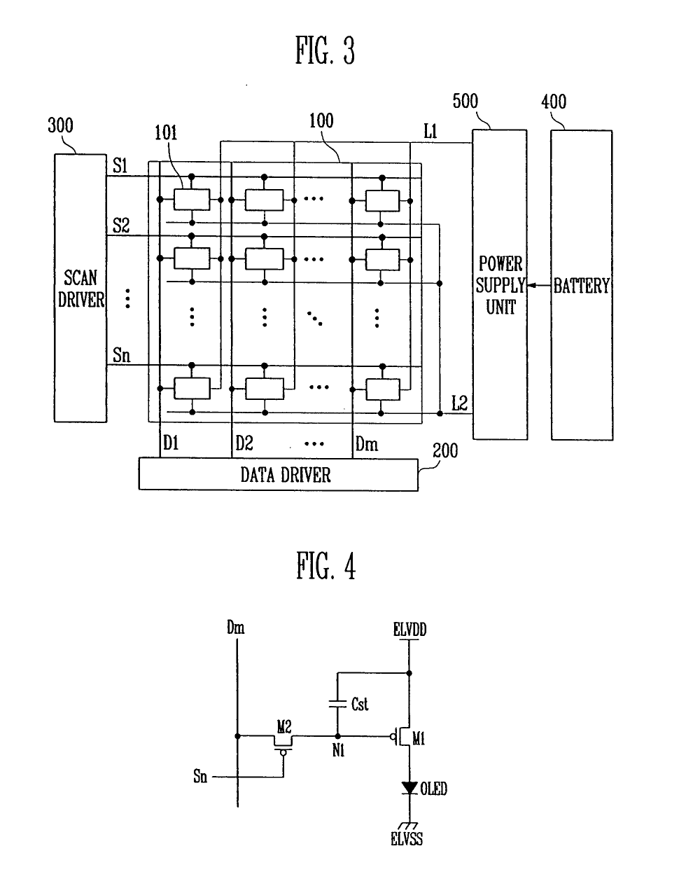

Another aspect is a voltage of 2V, for example, may be stored in a capacitor in a first pixel row of a plurality of pixel rows if, for example, a data signal has a voltage of 3V and a first power voltage is 5V. Also, a voltage of 1V may be charged in a capacitor (Cst) in a second pixel row if a data signal has a voltage of 3V and the first power voltage (ELVDD) is reduced to 4V. Accordingly, different voltages may be stored in the capacitor (Cst) of different rows even if the same data signal is input to the different rows. Different grey levels are displayed according to the ripple of the first power source (ELVdd) because each of the pixels displays grey levels corresponding to the voltage stored in the corresponding capacitor (Cst). Accordingly, banding noises are caused in the organic light emitting diode display device. The banding noise 20 is more easily observed due to more clear contrast with a region 10 in which the deterioration of image quality is caused by the banding noises if the entire pixel array emits full white light, as shown in FIG. 2.

Accordingly, the banding noise is generated in the organic light emitting diode display device if a ripple appears in the first power voltage (ELVdd). As a result, an image quality of the organic light emitting diode display device is reduced due to the defects in the grey levels displayed in a predetermined region.

FIG. 3 is a cross-sectional view showing an organic light emitting diode display device according to one embodiment. Referring to FIG. 3, the organic light emitting diode display device includes a pixel unit 100, a data driver 200, a scan driver 300, a battery 400 and a power supply unit 500.

The pixel unit 100 includes a plurality of data lines (D1,D2 . . . Dm−1,Dm), a plurality of scan lines (S1,S2 . . . Sn−1,Sn), a plurality of first power lines (L1) and second power lines (L2). The second power lines (L2) are shown as a plurality of wires, but may be deposited in the front surface of the pixel unit 100 configured as one film. The pixel unit 100 displays an image by causing a plurality of pixels 101 to emit light corresponding to a data signal, a scan signal, a first power source and a second power source.

The data driver 200 is connected to a plurality of the data lines (D1,D2 . . . Dm−1,Dm), and generates a data signal to transmit to one row, to the pixel unit 100 through the data line (D1,D2 . . . Dm−1,Dm).

The scan driver 300 is connected to a plurality of the scan lines (S1,S2 . . . Sn−1,Sn), and generates a scan signal to sequentially transmit to the pixel unit 100 through the scan line (S1,S2 . . . Sn−1,Sn).

The battery 400 may be used for a period since a power source is charged in the battery 400 if a power supply is shut off from the outside. The battery 400 may supply all of the electric power consumed in the use of portable apparatuses using the organic light emitting diode display device because the battery 400 is a terminal unit.

The power supply unit 500 receives power from the battery 400 and generates a first power voltage (ELVDD) and a second power voltage (ELVSS). The power supply unit 500 transmits the generated first power voltage (ELVDD) and the generated second power voltage (ELVSS) to the pixel unit 100 through a plurality of the first power lines (L1) and of the second power lines (L2). The voltage output from the battery 400 is not constant due to sudden fluctuations in load by the use of the portable apparatuses, and therefore a ripple is generated. Accordingly, when the power supply unit 500 uses the voltage output from the battery to generate the first power voltage (ELVDD) and the second power voltage (ELVSS), the power supply unit 500 generates the first power voltage (ELVDD) and the second power voltage (ELVSS) using two voltage control procedures so that ripple cannot be generated in the first power voltage (ELVDD) and the second power voltage (ELVSS). In some embodiments, the first power voltage (ELVDD) has a value substantially equal to the value of the battery voltage. In other embodiments, the first power voltage (ELVDD) has a value different from the value of the battery voltage. It is possible to prevent the ripple from being generated only in the first power voltage (ELVDD) since only the first power voltage (ELVDD) is related to the grey level display.

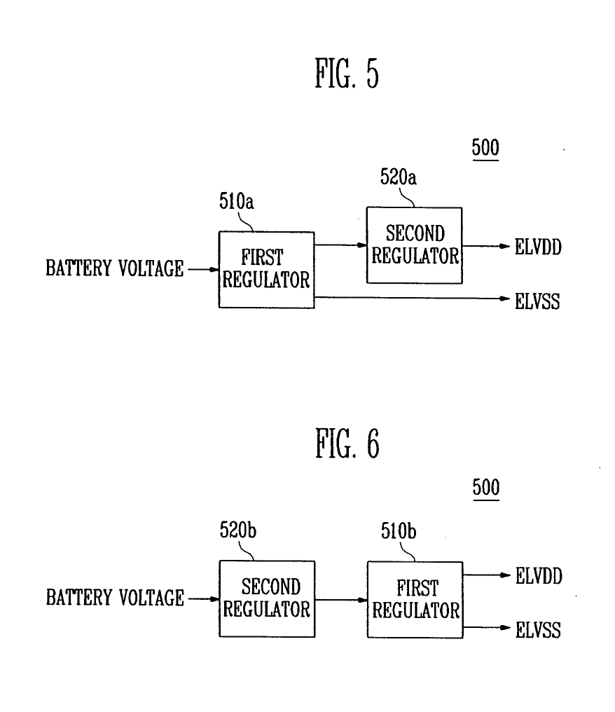

FIG. 4 is a circuit view showing a pixel of an organic light emitting diode display device. Referring to FIG. 4, the pixels 101 of the organic light emitting diode display device are connected to the data lines (Dm), the scan lines (Sn), and the first power lines (ELVDD) and the second power lines (ELVSS), and includes an organic light emitting diode (OLED), a first transistor (M1), a second transistor (M2) and a capacitor (Cst).

The organic light emitting diode (OLED) includes an anode electrode, a light emission layer and a cathode electrode, and the light emission layer is composed of a plurality of organic layers between the anode electrode and the cathode electrode. And, if the first power voltage (ELVDD) having a high value is connected to the anode electrode, and the second power voltage (ELVSS) is connected to the cathode electrode, the second power source (ELVSS) having a lower value than that of first power source (ELVDD), then an electric current flows from the anode electrode to the cathode electrode, and, as a result, light is emitted from the light emission layer corresponding to the flow of the electric current.

Another aspect is that the amount of the electric current flowing from the anode electrode to the cathode electrode of the organic light emitting diode (OLED) is controlled with a voltage of the gate of the first transistor (M1). The first transistor (M1) has a source connected to the first power source (ELVDD), a drain connected between the organic light emitting diodes (OLED), and a gate connected to the first node (N1). That is to say, the light emission of the organic light emitting diode (OLED) is controlled depending on the voltage of the gate in the first transistor (M1).

The data signal, transmitted through the data lines (Dm), is transmitted to the first node (N1) according to the scan lines (Sn) since the second transistor (M2) has a source connected to the data line (Dm), a drain connected to the first node (N1), and a gate connected to the scan line (Sn).

The capacitor (Cst) is connected between the first node (N1) and the first power line (ELVDD) to maintain a voltage of the first node (N1) for one frame period.

An electric current corresponding to the following Equation 1 flows to the organic light emitting diode (OLED).

$${I}_{OLED} = \frac{β}{2} {( Vgs - Vth )}^{2} = \frac{β}{2} {( Vdd - Vdata - Vth )}^{2} \qquad ( Eq . 1 )$$

### Herein,

I_{OLED} represents an electric current flowing to the OLED,
Vgs represents a voltage between the source and the gate of the first transistor (M1),
Vth represents a threshold voltage of the first transistor (M1),
Vdata represents a data signal voltage, and
β represents a gain factor of the first transistor (M1).

FIG. 5 is a block diagram showing an embodiment of a power supply unit as shown in FIG. 3. Referring to FIG. 5, the power supply unit 500 includes a first regulator 510a and second regulator 520a, where the second regulator 520a is connected to an output first regulator 510a.

The first regulator 510a may use a switching regulator, receives a predetermined voltage and converts the received voltage to a certain value of DC voltage, and then outputs the DC voltage. Accordingly, the first regulator 510a receives a battery voltage from the battery 400 to indirectly generate a first power voltage (ELVDD) and to generate a second power voltage (ELVSS) having a certain voltage.

The ripple is caused in the battery voltage outputted from the battery if a user carries out an operation with a high power consumption, for example talking over the telephone when the first power voltage (ELVDD) and the second power voltage (ELVSS) are being used by the pixel unit of the organic light emitting diode display device, such as those used in mobile phones, etc. Since the first regulator 510a uses a battery voltage to generate the first power voltage (ELVDD) and a second power voltage (ELVSS), a ripple is also generated in the first power voltage (ELVDD) and the second power voltage (ELVSS) if a ripple appears in the battery voltage. In particular, the electric current flowing to the organic light emitting diode (OLED) satisfies the Equation 1, and the first power voltage (ELVDD) is related to the value of the electric current flowing the organic light emitting diode (OLED), as shown in the Equation 1. Therefore, it is difficult to display the grey levels in the organic light emitting diode display device without noise if the ripple is generated in the first power voltage (ELVDD).

The second regulator 520a is used to prevent the ripple from being generated in the first power voltage (ELVDD) and the second power voltage (ELVSS), which are output from the first regulator 510a. The second regulator 520a is connected to an output terminal of the first regulator 510a to regulate the voltage of the first power voltage (ELVDD), thereby preventing the ripple of the first power source (ELVDD). The second regulator 520a can prevent ripple in the second power voltage (ELVSS) by isolating the first regulator 510a from any ripple causing effects on the first power source (ELVDD). Accordingly, the first power voltage (ELVDD) and the second power voltage (ELVSS) are regulated so that they can have a substantially constant voltage.

The second regulator 520a may use LDO (Low Drop Output Regulation). The LDO may output a signal free from noise, since it has an excellent PSRR (Power supply rejection ratio). Therefore, the second regulator 520a improves signal characteristics so that a substantially constant voltage can be output even if there is a ripple in the input voltage.

Accordingly, if the ripple is generated in a voltage transmitted from the battery 400 in telecommunication by mobile phones, etc., then the first power voltage (ELVDD), output from the second regulator 520a, has a constant value, and therefore an image quality of the organic light emitting diode display device is high quality and substantially without banding noises.

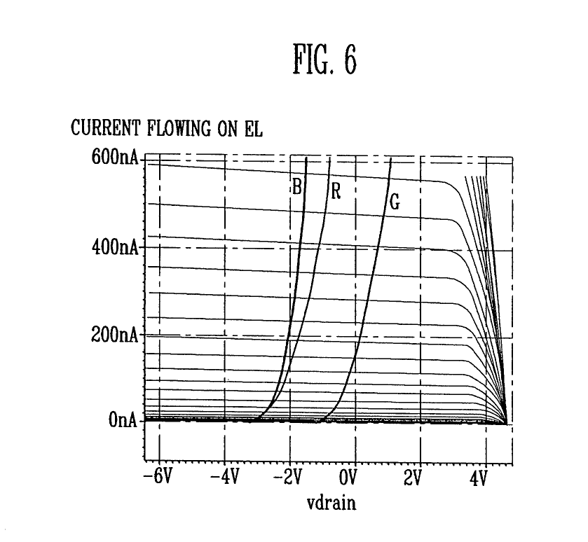

FIG. 6 is a block diagram showing another embodiment of a power supply unit as shown in FIG. 3. Referring to FIG. 6, the power supply unit 500 includes a first regulator 510b and a second regulator 520b. The battery voltage, transmitted from the battery 400, is input to the second regulator 520b. The second regulator 520b regulates the battery voltage. For example, while the battery voltage may experience one or more voltage sags, the regulator generates an output voltage with the sags reduced in significance. In some embodiments, the sag may have a smaller amplitude, and/or may have a longer or shorter duration in the regulated voltage. The output of the second regulator 520b is connected to an of the first regulator 510b, which generates the first power voltage (ELVDD) and the second power voltage (ELVSS).

Accordingly, even when a ripple is generated in a voltage due to telecommunication, etc., the battery voltage is regulated in the second regulator 520b to be a substantially constant voltage. The regulated voltage is then transmitted to the first regulator 510b, which generates a first power voltage (ELVDD) and a second power voltage (ELVSS).

Accordingly, even if the ripple is generated in a voltage of the predetermined power source transmitted from the battery 400, the first power voltage (ELVDD) and the second power voltage (ELVSS) may be output at a substantially constant voltage, and therefore an image quality of the organic light emitting diode display device is high and without banding noise.

According to the organic light emitting diode display device of the presented embodiments, and the driving method thereof, the organic light emitting diode display device used in portable apparatuses such as mobile phones may have high image quality because of low banding noise caused by fluctuation in its power consumption.

The description proposed herein has certain embodiments as examples for the purpose of illustration only, and are not intended to be limiting. It should be understood that other equivalents and modifications can be made thereto without departing from the spirit and scope of the invention as apparent to those skilled in the art.

What is claimed is:

1. An organic light emitting diode display device comprising:
a pixel unit comprising pixels configured to receive a data signal, a scan signal, a first power voltage, and a second power voltage, and to display an image based on the received signals and voltages;
a data driver configured to transmit the data signal to the pixel unit;
a scan driver configured to transmit the scan signal to the pixel unit;
a battery configured to transmit a predetermined power voltage;
a first regulator configured to receive the predetermined power voltage, to generate a first power voltage signal and the second power voltage, and to transmit the first power voltage signal and the second power voltage; and
a second regulator configured to receive and to regulate the first power voltage signal to generate the first power voltage.

2. The organic light emitting diode display device according to claim 1, wherein the second regulator is integrated with the first regulator.

3. The organic light emitting diode display device according to claim 1, wherein the second regulator comprises an LDO.

4. The organic light emitting diode display device according to claim 1, wherein the pixel comprises:
an organic light emitting diode including a plurality of organic layers and configured to emit light if an electric current flows in the organic layer;
a first transistor comprising:
a first electrode connected to a pixel power source;
a second electrode connected to the organic light emitting diode; and
a third electrode connected to a first node;
a second transistor comprising:
a first electrode configured to receive the data signal;
a second electrode connected to the first node; and
a third electrode configured to receive the scan signal; and
a capacitor comprising:
a first electrode connected to a pixel power source; and
a second electrode connected to the first node.

5. The organic light emitting diode display device according to claim 1, wherein the first power voltage has a higher value than the second power voltage.

6. The organic light emitting diode display device according to claim 1, wherein the first power voltage has a value substantially equal to the value of the predetermined power voltage.

7. An organic light emitting diode display device comprising:
a pixel unit comprising pixels configured to receive a data signal, a scan signal, a first power voltage, and a second power voltage, and to display an image;
a data driver configured to transmit the data signal to the pixel unit;
a scan driver configured to transmit the scan signal to the pixel unit;
a battery configured to transmit a predetermined power voltage;
a first regulator configured to receive a power voltage signal, to generate the first power voltage and the second power voltage based on the received power voltage signal, and to transmit the first power voltage and the second power voltage; and
a second regulator configured to receive the predetermined power voltage, to regulate the predetermined power voltage to generate the power voltage signal, and to transmit the power voltage signal to the first regulator.

8. The organic light emitting diode display device according to claim 7, wherein the second regulator is integrated with the first regulator.

9. The organic light emitting diode display device according to claim 7, wherein the second regulator comprises an LDO.

10. The organic light emitting diode display device according to claim 7, wherein the pixel comprises:
an organic light emitting diode including a plurality of organic layers and configured to emit light if an electric current flows in the organic layer;
a first transistor comprising:
a first electrode connected to a pixel power source;
a second electrode connected to the organic light emitting diode;
a third electrode connected to a first node;
a second transistor comprising:
a first electrode configured to receive the data signal;
a second electrode connected to the first node; and
a third electrode configured to receive the scan signal; and
a capacitor comprising:
a first electrode connected to a pixel power source; and
a second electrode connected to the first node.

11. The organic light emitting diode display device according to claim 7, wherein the first power voltage has a higher value than the second power voltage.

12. The organic light emitting diode display device according to claim 7, wherein the first power voltage has a value substantially equal to the value of the predetermined power voltage.

13. Another aspect is a method of driving an organic light emitting diode display device capable of displaying an image using a data signal, a scan signal, a first power voltage, and a second power voltage, the method comprising:
regulating a voltage received from a battery to generate the first power voltage and the second power voltage; and
reducing voltage sag, wherein the voltage received from the battery has a first voltage sag, and the first power voltage has a second voltage sag, and the amplitude of the first voltage sag is larger than the amplitude of the second voltage sag.

14. The method according to claim 9, wherein regulating of the voltage received from the battery is performed with a first regulator, and reducing the voltage sag is performed with a second regulator.

15. The method according to claim 13, wherein the first power voltage has a higher value than the second power voltage.

16. The method according to claim 13, wherein the first power voltage has a value substantially equal to the value of the voltage received from the battery.

17. Another aspect is a method of driving an organic light emitting diode display device capable of displaying an image using a data signal, a scan signal, a first power voltage, and a second power voltage, the method comprising:
reducing ripple of a power voltage, received from a battery to generate a reduced ripple battery voltage;
regulating the reduced ripple battery voltage; and
generating a first power voltage and a second power voltage based on the regulated reduced ripple battery voltage.

18. The method according to claim 17, wherein reducing the ripple of the power voltage is performed with a second regulator, and the generation of the first power voltage and the second power voltage is performed with a first regulator.

19. The method according to claim 17, wherein the first power voltage has a higher value than the second power voltage.

20. The method according to claim 17, wherein the first power voltage has a value substantially equal to the value of the voltage received from the battery.
